(19) United States
(12) Patent Application Publication
(10) Pub. No.: US 2008/0115327 A1
(43) Pub. Date: May 22, 2008

(54) Mounting Plate for Adjustably Mounting Furniture Hinges on the Frame of Articles of Furniture

(75) Inventors: Thorsten Eberl, Muehltal (DE); Markus Herper, Muehltal (DE)

Correspondence Address: NORRIS, MCLAUGHLIN & MARCUS, P.A., 875 THIRD AVE, 18TH FLOOR, NEW YORK, NY, 10022, US

(73) Assignee: MEPLA-Werke Lautenschlaeger GmbH & Co. KG, Reinheim (DE)

(21) Appl. No.: 11/574,269

(22) PCT Filed: Aug. 10, 2005
(86) PCT No.: PCT/EP05/08662

§ 371 Date: Feb. 1, 2008

(30) Foreign Application Priority Data
Aug. 27, 2004 (DE) 20 2004 013 401.2

(51) Int. Cl. E05D 7/00

(52) U.S. Cl. 16/382

(57) ABSTRACT

The invention relates to a multipart mounting plate (10) for furniture hinges which comprises a base (12), fastened to a supporting wall of a piece of furniture, and an elongate top (16) which is adjustably retained in relation to the base (12) and on which the supporting wall stop part of a pertaining hinge can be mounted. A center part (14) is arranged between the base (12) and the top (16) and is retained in such a manner that it can be displaced longitudinally on the base but is secured from being lifted off. The top (16), in the area of the end projecting from the frame and being front in the position of fastening according to the invention, is mounted on the center part (14) so as to be swiveled about an axis which extends on the supporting wall at an angle to the longitudinal extension of the top (16) and in parallel to the fastening plane of the base (12). According to the invention, an adjusting mechanism allows to fix the top (16) in selectable swiveling positions on the center part (14).

The invention relates to a multipart mounting plate for furniture hinges with a lower portion, which may be fastened to the support wall of an article of furniture, and an elongate lower portion, which is adjustably mounted relative to the upper portion and on which the support wall engagement portion of an associated hinge may be mounted.

Such mounting plates, in which an upper portion suitably constructed to support the support wall engagement portion, constructed in the form of a support arm, of a furniture hinge is mounted on a lower portion, which, for its part, may be secured to the support wall of the frame of an article of furniture, i.e. generally the inner surface of the side wall of the carcass of a cupboard, are known (e.g. DE 20120238 U1). This adjustable mounting of the upper portion generally serves to produce an additional displacement of the hinge in a coordinate direction not available with one part mounting plates.

The hinges which are nowadays commonly used on such mounting plates serve to pivotably connect door leaves which, in the closed state, define an angle of 90° with the support wall of the carcass, wherein, depending on the construction of the hinge mechanism, the door leaf permits opening of the door leaf through 90° or even a greater angle.

There are now also cupboards, in which the support wall, in the door closed position, defines an angle with the door leaf, which differs considerably from 90°. In the corner cupboards of built-in furniture systems and kitchen furniture, this angle is, for instance, 135°. Furthermore, with special furniture, e.g. furniture made specially for certain predetermined spatial conditions, other angles between the door leaf and support wall are possible in the door closed position. The mass produced four joint hinges with the associated mounting plates cannot be used in such cases because a door leaf connected with them either could not be opened through the full opening angle made inherently possible by the kinematics of the joint mechanism, if the angle between the support wall and door leaf is greater than 90° or, in the case of joint hinges with an opening angle of up to 115°, than 115°. For these applications, hinges were therefore produced with support arms which were so modified as regards the joint in accordance with the special case that the mounting, which was angularly altered with respect to the normal case (90°), was compensated for by appropriate positioning of the pivot point of the joint mechanism with respect to the support arm since the possibilities present in the known hinges for angular adjustment of the support arm are not sufficient in order to be able to use them for the described special applications. The manufacturing costs for such special support arms and thus for the hinges constructed with the support arms are disproportionately high in comparison to normal hinges because the high tooling costs for the stamping press tools or die-casting moulds necessary for the manufacture of the support arms can be borne by only very small numbers. The fully or partially automated assembly of the hinge components, which is possible in many cases with normal hinges, also presupposes adequately high numbers, which are not achieved with the hinges in question so that costly manual assembly of the hinges is necessary.

Hinges, which may be adjustably mounted on the normal (one part or multipart) mounting plates have thus already been developed, in which the front portion of the hinge support arm is a separately manufactured joint carrier, which is pivotally mounted on the actual support arm so that as a result of altering the pivotal position of the joint carrier and fixing the joint carrier in an altered position, adaptation is possible such that the hinges in question are also usable for articles of furniture, in which the door leaf defines an angle with the carcass support wall differing from 90°, in the closed position (DE 3217104 C2).

By contrast, it is the object of the invention to provide a mounting plate for normal hinges with a one-part support arm, which permits the use of these normal hinges even under the special conditions described.

Starting from a mounting plate of the typed referred to above, this object is solved in accordance with the invention if arranged between the lower portion and the upper portion there is a central portion, which is mounted so as to be movable on the lower portion in the longitudinal direction but is secured against lifting away, if in the region of its front end directed out of the cupboard carcass, in the predetermined fastened position, the upper portion is mounted on the central portion so as to be pivotable about an axis which extends transversely to the length of the upper portion and parallel to the fastening plane of the lower portion on the support wall and if an adjustment mechanism is provided, which fixes the upper portion on the central portion in selectable pivotal positions. The change in the relative alignment of the support arm of the hinge to be fastened to the mounting plate is thus effected in this case by changing the inclination of the upper portion of the mounting plate, whereby in the context of the structurally predetermined pivotability, an adjustment of the angle of a closed door leaf relative to the support wall differing from 90° may be set.

In a preferred embodiment of the invention, the lower portion, which is provided with a substantially flat lower surface on the support wall side, has an elongate cut-out, whose lateral longitudinal sides are substantially straight and in which the central portion, whose breadth is dimensioned to correspond to the free width of the cut-out, is guided to be movable in the longitudinal direction. It is then recommended that the construction be such that the cut-out is provided on its lower surface, in the vicinity of its longitudinal sides, with elongate, strip-shaped undercuts, into which narrow, strip-shaped edge strips, which project laterally from respective opposite longitudinal sides of the central portion, engage. It is then only possible to pull the central portion out of the cut-out towards the lower surface of the lower portion when the mounting plate is demounted.

The upper surface of the edge strips on the central portion and the wall regions, directed towards it and facing downwardly, of the undercuts are then conveniently provided with complementary serrations or grooves extending transversely to the longitudinal direction, which can fix a longitudinal setting of the central portion in the cut-out.

It is then recommended that the height of the undercuts measured at right-angles to the fastening plane of the lower portion and the height of the edge strips projecting laterally from the central portion are so dimensioned that the complementary serrations or grooves in the undercuts on the lower portion or the upper surfaces of the edge strips are forced into form-locking engagement in the predetermined fastened position of the mounting plate on the support wall of an article of furniture. Longitudinal movement of the central portion is thus only possible when the lower portion has a distance from the support wall of an article of furniture, to which the mounting plate is to be fastened, corresponding approximately to the depth of the serrations or grooves.

In order to fasten the mounting plate to the support wall, at least two spaced through openings can be provided, through which the shafts of fastening screws may be screwed into the support wall of the carcass of an article of furniture.

The through openings are then advantageously constructed in the form of longitudinal holes arranged in alignment on opposite sides of the cut-out transversely to the longitudinal direction, which holes enable a vertical adjustment of the mounting plate on the support wall of the cupboard so long as the fastening screws have not yet been screwed tightly.

In order to be able to continuously adjust the upper portion to different pivotal angles relative to the central portion and then to fix it in this position, it is recommended that provided in the central portion on the side directed towards the upper portion there is an elongate groove with a constricted opening, in which a headpiece disposed at the end of a threaded peg is arranged so as to be longitudinally movable but secured against coming out at right angles to the longitudinal direction of the groove and that the threaded peg which is provided at its end opposite to the headpiece with means for applying a rotary tool, is screwed into a threaded through bore in the upper portion. By the application and rotation of a rotary tool, e.g. a screwdriver, to the accessible end of the threaded peg, the upper portion can thus then be continuously moved into the desired oblique alignment with the central portion and, as a consequence of the self-locking of the engaging screwthreads of the threaded peg and the threaded bore, fixed in position.

In a further advantageous embodiment of the invention, the groove then has a cross-section of circular shape over more than 180° and the headpiece is constructed in the form of a ball, the radius of which is substantially equal to the radius of the circular-shaped cross-section of the groove. The headpiece is thus received in the groove in the manner of a ball joint so that the changing inclination of the threaded peg when the upper portion pivots does not result in jamming of the head portion in the groove.

The spherical headpiece is conveniently connected to the threaded shaft by means of an interposed unthreaded shaft section of reduced diameter.

The invention will be described in more detail in the following description of an exemplary embodiment in conjunction with the drawings, in which:

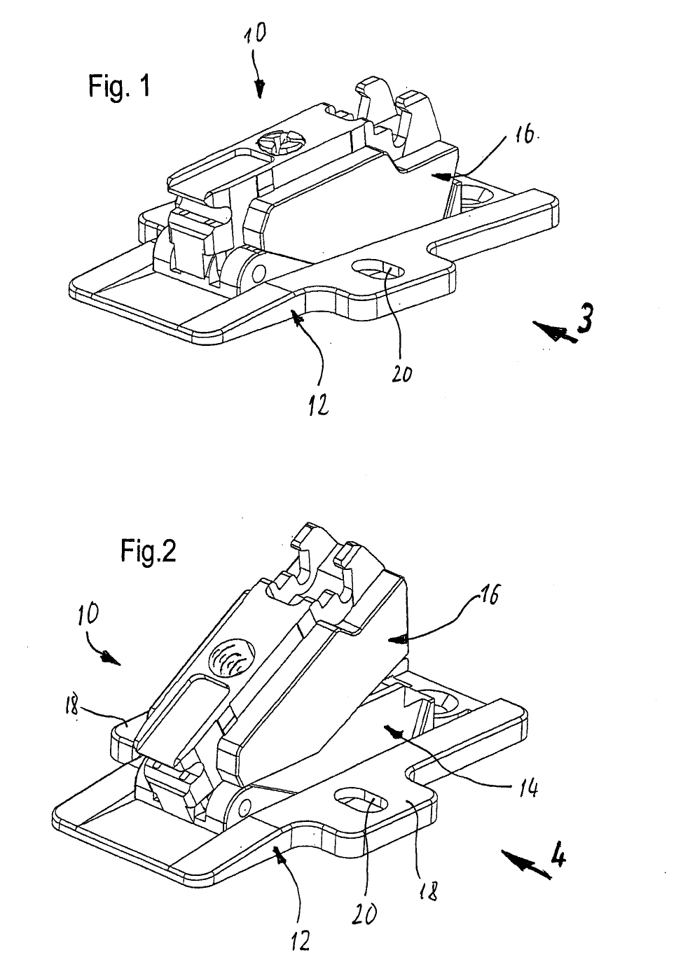

FIG. 1 is an isometric view of a mounting plate constructed in accordance with the invention in a first setting of the alignment of the upper portion relative to the lower portion of the mounting plate;

FIG. 2 is an isometric view, corresponding to FIG. 1, of the mounting plate, in which a substantially inclined alignment of the upper portion to the lower portion is shown;

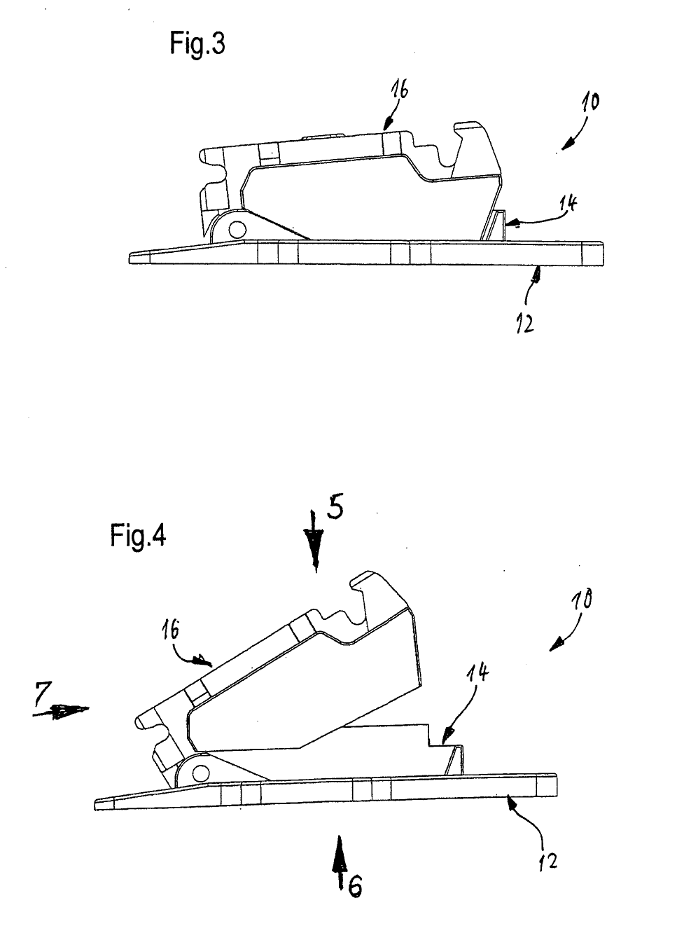

FIG. 3 is a side view of the mounting plate, seen in the direction of the arrow 3 in FIG. 1;

FIG. 4 is a side view of the mounting plate, seen in the direction of the arrow 4 in FIG. 2;

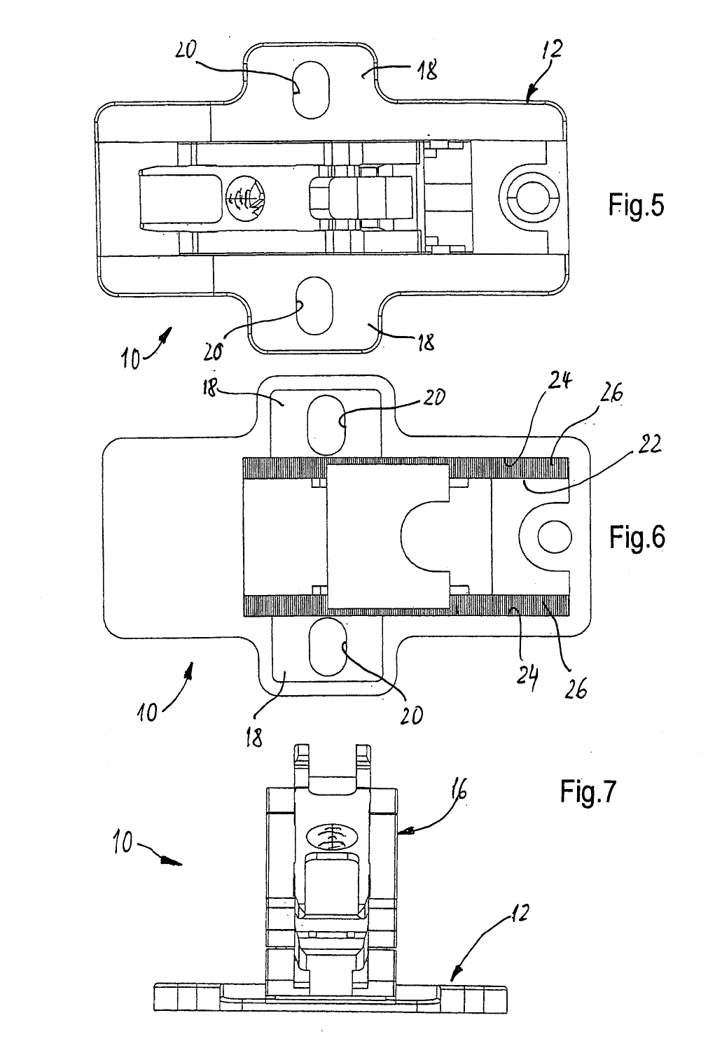

FIG. 5 is a plan view of the mounting plate, seen in the direction of the arrow 5 in FIG. 4;

FIG. 6 is an underneath view of the mounting plate, seen in the direction of the arrow 6 in FIG. 4;

FIG. 7 is a front view of the mounting plate, seen in the direction of the arrow 7 in FIG. 4; and

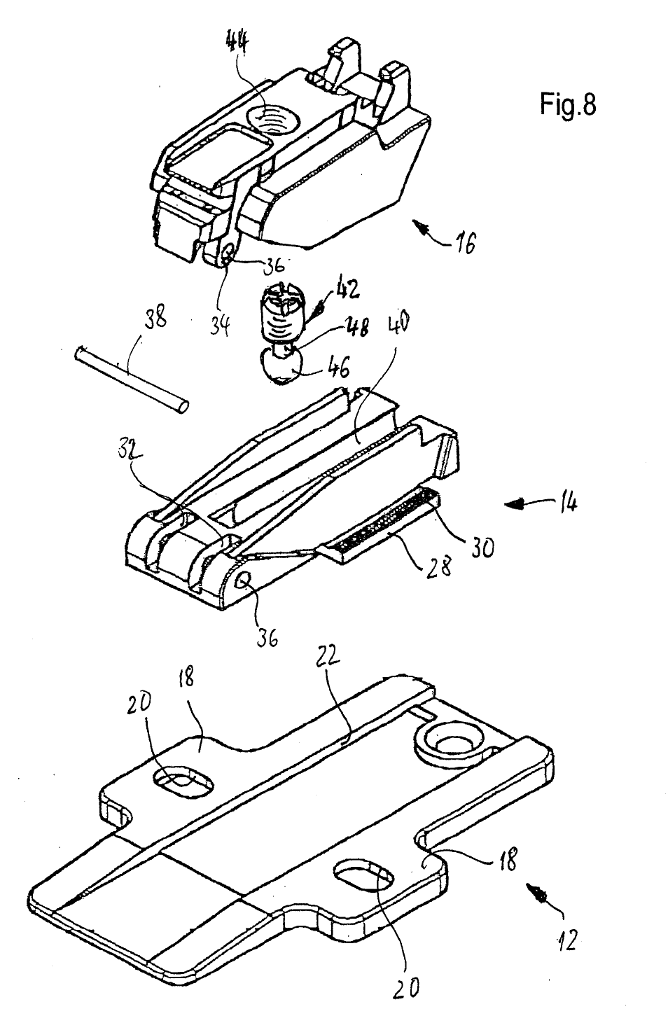

FIG. 8 is an isometric exploded view of the components of the mounting plate in accordance with the invention as shown in FIG. 1.

The mounting plate, which is shown in different views and different positions in FIGS. 1 to 7 and is designated as a whole with 10, is composed, as may best be seen in the exploded view of FIG. 8, of three main functional portions, namely a lower portion 12, which may be fastened to the support wall of an article of furniture, e.g. the side wall of the carcass of a cupboard, a central portion 14, which is longitudinally movably retained on this lower portion, and an upper portion 16, which is pivotally mounted on the central portion.

The elongate, plate-shaped lower portion 12 of the mounting plate 2 has two wing-like formations 18, which project from opposite longitudinal sides and provided in which there is a respective through opening in the form of aligned elongate holes 20, extending at right angles to the longitudinal dimension, through which the threaded shafts of fastening screws, which are not shown, may be screwed into associated bores in the support wall of the article of furniture. A movable fastening of the lower portion 12 to the support wall is thus possible within the limits of the longitudinal dimension of the elongate holes 20.

Provided centrally between the wing formations 18 on the lower portion 12 is an elongate cut-out 22, whose longitudinal side edges are substantially straight and which passes right through over at least a proportion of its length and in which the central portion 14, whose breadth is dimensioned to correspond to the free width of the cut-out 22, may be inserted from below.

In the region of its longitudinal sides, the cut-out 22 is provided on the under surface with elongate, strip-shaped undercuts 24 with serrations 26 aligned with the flat lower fastening surface of the lower portion 12 (FIG. 6). Projecting from the opposite longitudinal sides of the central portion 14 are laterally narrow, strip-shaped edge strips 28 (FIG. 8), which are provided on their upper surface with complementary serrations 30. The edge strips 28, which engage beneath the undercuts 24, make it impossible for the central portion 14 to come out of the upper portion 12 in the upward direction, whereby the complementary serrations 26, 30 only permit longitudinal movement of the central portion 14 within the cut-out 22 when these serrations 26, 30 are not forced into engagement. This is only the case when the underside of the lower portion 12 has not yet been screwed into firm engagement with the associated support wall since the height of the undercuts measured at right angles to the fastening plane of the lower portion and the height of the edge strips 28 projecting laterally from the central portion 14 are so dimensioned that the complementary serrations are forced into form-locking engagement in the predetermined fastened position of the mounting plate on the support wall of the article of furniture.

At its front end region, which is directed out of the carcass in the predetermined mounted position of the mounting plate 10 on the support wall of the carcass of a piece of furniture, the central portion 14 has two laterally spaced slots 32, into which associated, projecting lug-like formations 34 on the front end of the upper portion 16 may be fittingly introduced. An elongate peg 38 may be introduced through a through-bore 36, which extends transversely in the vicinity of the slots and the lug-like formations, which peg then mounts the upper portion pivotally at its upper end on the central portion 14. Respective different pivotal positions of the upper portion 16 on the central portion 14 are illustrated in FIGS. 1 and 2 (and 3 and 4). In order to be able to adjust the upper portion 16 in a desired pivotal position relative to the central portion and then to fix it at this setting, an elongate open groove 40 with a constricted mouth is provided in the central portion 14, which groove is open at its rear end so that a headpiece, which is attached to the lower end of a threaded peg 42 by means of a reduced diameter, unthreaded shaft portion, may be inserted there so as to be longitudinally movable but secured against coming out at right angles to the longitudinal direction of the groove. The threaded peg 42 may, for its part, be screwed into an associated threaded bore 44 in the upper portion 16. By rotating the threaded peg 42 by means of a rotary tool inserted through the threaded bore, which is open at the top, the depth to which the threaded peg 42 is screwed into the threaded bore 44 may be altered, whereby the desired pivotal movement of the upper portion 16 relative to the central portion 14 necessarily occurs. The pitch of the complementary threaded bore of the threaded peg 42 and of the threaded bore 44 is so selected that the screw-threaded connection is self-locking so that a set pivotal position does not need to be additionally secured.

In order to prevent the headpiece inserted into the groove 40 becoming wedged in the groove when the pivotal movement occurs, the groove 40 is of circular arcuate shape over more than 180° and the headpiece is constructed in the form of a ball 46 with a radius which corresponds to the radius of the circular arcuate cross-section of the groove 40. The spherical headpiece is conveniently not directly on the underside of the threaded peg 42 but via a reduced diameter, unthreaded shaft section 48, whereby in the event of pivotal movement of the threaded shaft 42 as a consequence of the pivotal movement of the upper portion 16 relative to the central portion 14, the threaded shaft cannot come into contact with the upper surface of the central portion 14.

In the exemplary embodiment described above, the upper surface of the upper portion is so shaped in a manner known per se (e.g. DE 20120237 U1) that the support arm of an associated hinge can be installed by locking on and removed by unlocking without using a tool. The manner in which the hinge support arm is installed on the mounting plate is, however, not the subject of the present invention so that the special features provided on the upper portion for this purpose need not be described here in detail.

1-10. (canceled)

11. A multipart mounting plate (10) for furniture hinges including a lower portion (12), which may be secured to the support wall of an article of furniture, and an elongate upper portion (16), which is mounted so as to be movable relative to the lower portion (12) and on which the support wall engaging portion of an associated hinge may be mounted, characterised in that arranged between the lower portion (12) and the upper portion (16) there is a central portion (14), which is mounted so as to be movable on the lower portion in the longitudinal direction but is secured against lifting away, in the region of its front end directed out of the cupboard carcass, in the predetermined fastened position, the upper portion (16) is mounted on the central portion (14) so as to be pivotable about an axis which extends transversely to the length of the upper portion (16) and parallel to the fastening plane of the lower portion (12) on the support wall and an adjustment mechanism is provided, which fixes the upper portion (16) on the central portion (14) in selectable pivotal positions, that provided in the central portion (14) on the side directed towards the upper portion (16) there is an elongate groove (40) with a constricted opening, in which a headpiece disposed at the end of a threaded peg (22) is arranged so as to be longitudinally movable but secured against coming out at right angles to the longitudinal direction of the groove and that the threaded peg which is provided at its end opposite to the headpiece with means for applying a rotary tool, is screwed into a threaded through bore (44) in the upper portion (16).

12. A mounting plate as claimed in claim 11, characterised in that the groove (40) has a cross-section of circular shape over more than 180° and that the headpiece is constructed in the form of a ball (46), the radius of which is substantially equal to the radius of the circular-shaped cross-section of the groove (40).

13. A mounting plate as claimed in claim 12, characterised in that the spherical headpiece (46) is connected to the threaded peg (42) by means of an interposed unthreaded shaft section (48) of reduced diameter.

14. A mounting plate as claimed in claim 11, characterised in that the lower portion, which is provided with a substantially flat lower surface on the support wall side, has an elongate cut-out (22), whose lateral longitudinal sides are substantially straight and in which the central portion (14), whose breadth is dimensioned to correspond to the free width of the cut-out (22), is guided to be movable in the longitudinal direction.

15. A mounting plate as claimed in claim 14, characterised in that the cut-out (22) is provided on its lower surface, in the vicinity of its longitudinal sides, with elongate, strip-shaped undercuts (24), into which narrow, strip-shaped edge strips (22), which project laterally from respective opposite longitudinal sides of the central portion (14), engage.

16. A mounting plate as claimed in claim 15, characterised in that the upper surface of the edge strips (28) on the central portion (14) and the wall regions, which are directed towards the latter and face downwards, of the undercuts are provided with complementary serrations (30; 26) or grooves extending transversely to the longitudinal direction.

17. A mounting plate as claimed in claim 13, characterised in that the height of the undercuts measured at right-angles to the fastening plane of the lower portion (12) and the height of the edge strips (28) projecting laterally from the central portion are so dimensioned that the complementary serrations (30; 26) or grooves in the undercuts (24) on the lower portion (12) and the upper surfaces of the edge strips (28), respectively, are forced into form-locking engagement in the predetermined fastened position of the mounting plate (10) on the support wall of an article of furniture.

18. A mounting plate as claimed in claim 11, characterised in that provided in the lower portion (12) spaced from the cut-out (22) there are at least two spaced through openings, through which the shafts of fastening screws may be screwed into the support wall of the carcass of an article of furniture.

19. A mounting plate as claimed in claim 18, characterised in that the through openings are elongate holes (20) arranged in alignment on opposite sides of the cut-out (20) transversely to the longitudinal direction.
